(19) United States
(12) Patent Application Publication
(10) Pub. No.: US 2010/0284192 A1
(43) Pub. Date: Nov. 11, 2010

(54) LED lighting fixture

(75) Inventor: Hui-Yu Chen, Daya Township (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: JARRER CO., LTD., Taichung Hsien (TW)

(21) Appl. No.: 12/592,454

(22) Filed: Nov. 24, 2009

(30) Foreign Application Priority Data
May 11, 2009 (TW) 098115544

(51) Int. Cl. F21V 5/00

(52) U.S. Cl. 362/311.02

(57) ABSTRACT

An LED lighting fixture includes a lamp seat unit, a rotary unit and a first sealing member. The lamp seat unit includes a main body that has an outer peripheral surface formed with an external thread, and an LED lamp disposed in a front end thereof. The rotary unit includes a tube body surrounding the lamp seat unit and having an inner peripheral surface formed with an internal thread engaging the external thread, and a convex lens disposed in the tube body. When the tube body is rotated relative to the lamp seat unit, the lamp seat unit is movable in the axial direction.

### CROSS-REFERENCE TO RELATED APPLICATION

This application claims priority to Taiwanese Application No. 098115544, filed May 11, 2009, the disclosure of which is incorporated herein by reference.

### BACKGROUND OF THE INVENTION

1. Field of the Invention

The invention relates to a light emitting diode (LED) lighting fixture, more particularly to an LED lighting fixture capable of adjusting a focal distance.

2. Description of the Related Art

As shown in FIGS. 1 and 2, a conventional lighting fixture capable of adjusting a focal distance comprises a lamp housing 1, a lens barrel 2 extending along an axial direction (X) and mounted on the lamp housing 1, a rotatable barrel 3 extending along the axial direction (X) and mounted within the lens barrel 2, and a lens device 4 disposed in the rotatable barrel 3. The lens barrel 2 has two cam grooves 201, 202 formed in an inner surface of the lens barrel 2. The rotatable barrel 3 has two axially extending guide slots 301, 302 formed through a periphery of the rotatable barrel 3. The lens device 4 has a frame 401, a lens 402 mounted on the frame 401, and two guide pins 403, 404 disposed on an outer periphery of the frame 401. The guide pins 403, 404 extend respectively through the guide slots 301, 302 and engage respectively the cam grooves 201, 202 in the lens barrel 2. Once the rotatable barrel 3 is rotated, the lens device 4 slides in the lens barrel 2 along the axial direction (X).

However, the lens barrel 2 and the rotatable barrel 3 must be machined to allow the guide pins 403, 404 of the lens device 4 to engage fittingly the cam grooves 301, 302 of the lens barrel 2. As a result, the manufacturing process for the conventional lighting fixture is troublesome. Furthermore, since the guide pins 403, 404 cannot be mounted directly to the lens 402, the frame 401 is necessary for mounting the guide pins 403, 404 to the rotatable barrel 2.

### SUMMARY OF THE INVENTION

Therefore, the object of the present invention is to provide an LED lighting fixture capable of alleviating the above drawbacks of the prior art.

Accordingly, a light emitting diode (LED) lighting fixture of the present invention comprises a lamp seat unit, a rotary unit, and a first sealing member. The lamp seat unit includes a main body that extends along an axial direction, and that has an outer peripheral surface formed with an external thread. The LED lamp is disposed in a front end of the main body. The rotary unit includes a tube body that extends along the axial direction, that surrounds the lamp seat unit, and that has an inner peripheral surface formed with an internal thread that threadedly engages the external thread of the main body so as to permit movement of the tube body relative to the lamp seat unit during rotation of the tube body relative to the lamp seat unit. A convex lens is mounted in the tube body at a position in front of the LED lamp of the lamp seat unit, such that when the tube body is rotated relative to the lamp seat unit, the lamp seat unit is movable in the axial direction between a first position, where the convex lens is proximate to the LED lamp, and a second position, where the convex lens is distal from the LED lamp.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional lighting fixture;

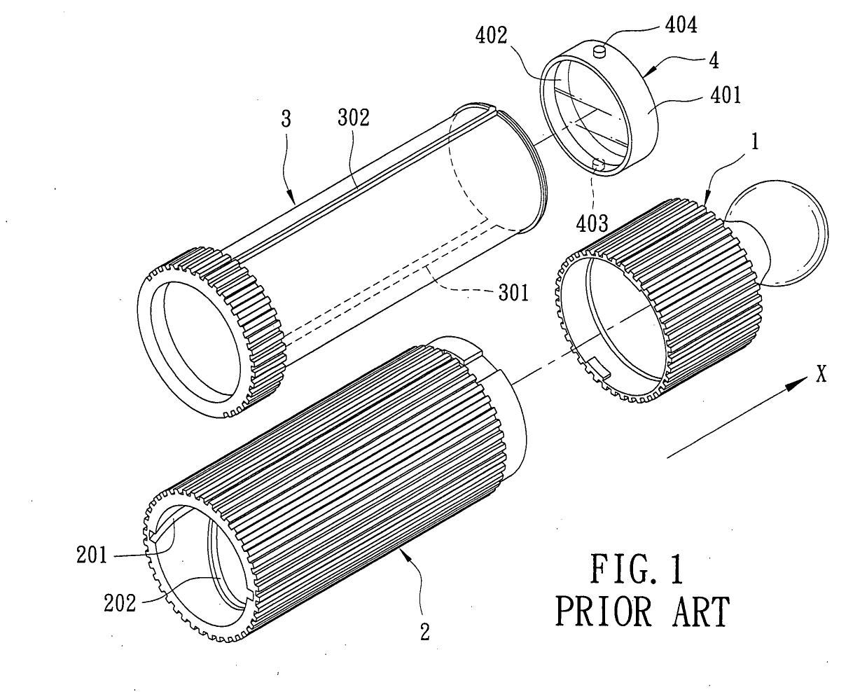

FIG. 2 is a sectional view of a lens barrel of the conventional lighting fixture;

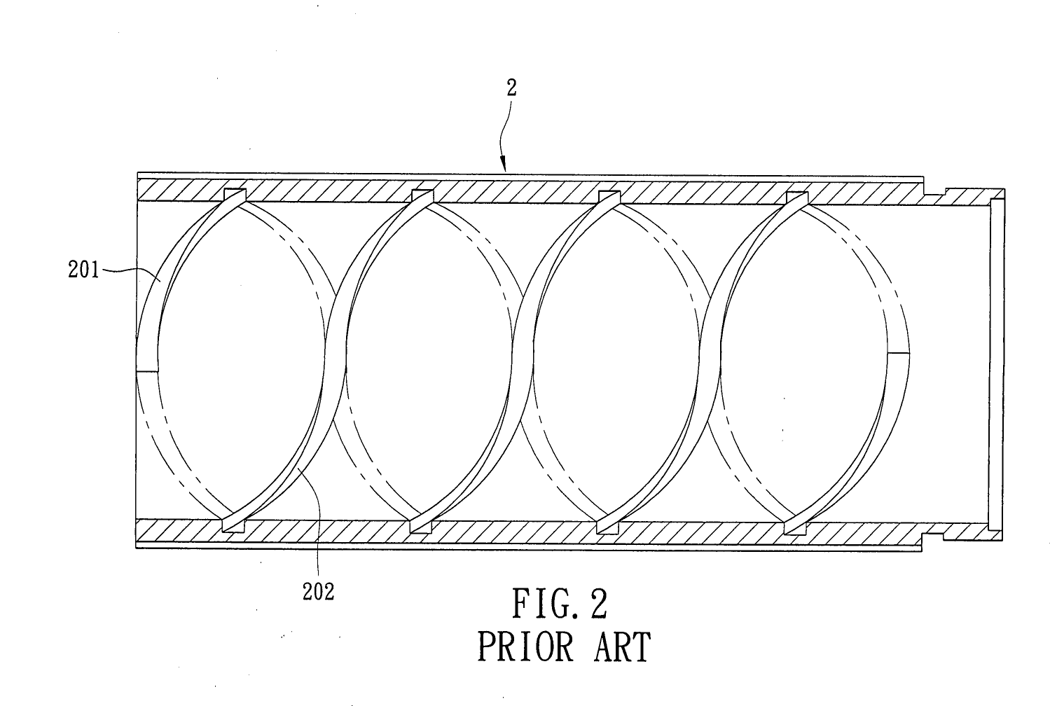

FIG. 3 is a partly sectional view of a preferred embodiment of an LED lighting fixture according to the present invention, illustrating a lamp seat unit disposed at a first position; and

FIG. 4 is a partly sectional view of the LED lighting fixture, illustrating the lamp seat unit disposed at a second position.

### DETAILED DESCRIPTION OF THE PREFERRED EMBODIMENT

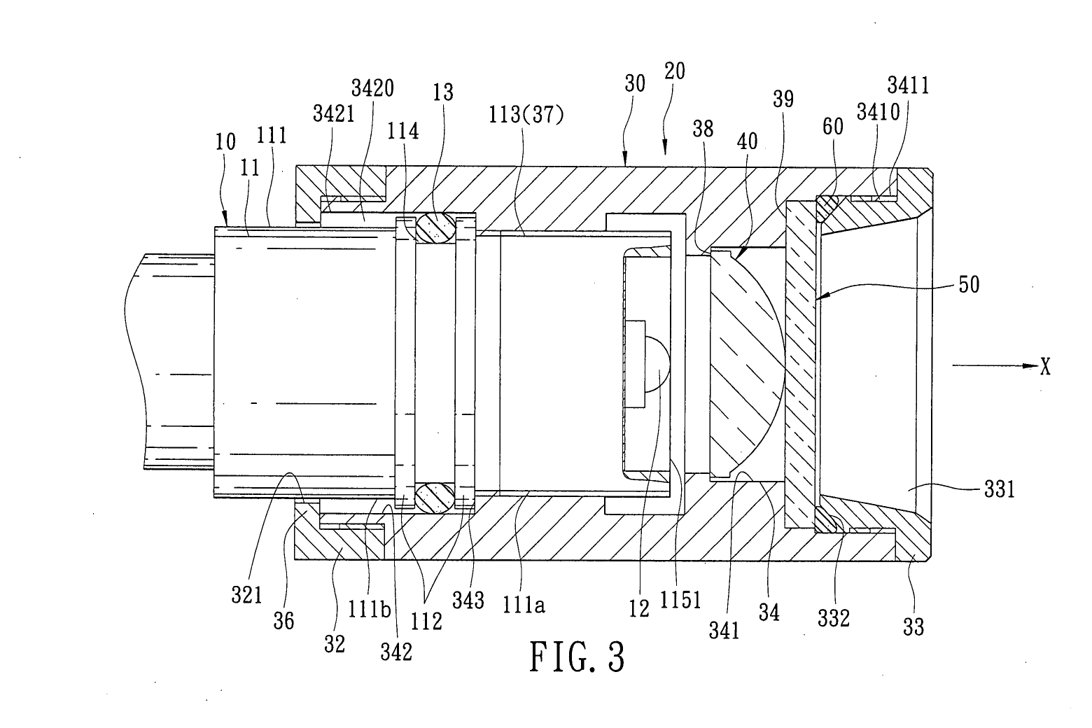

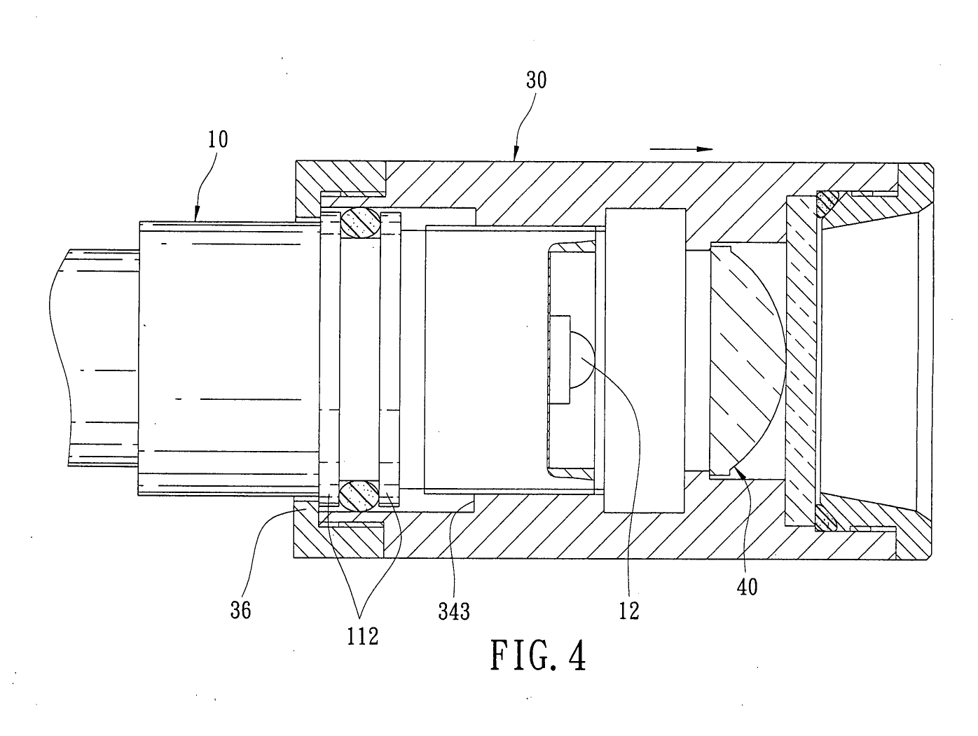

As shown in FIGS. 3 and 4, a preferred embodiment of an LED lighting fixture according to the present invention comprises a lamp seat unit 10, a rotary unit 20, and a first sealing member 13.

The lamp seat unit 10 includes a main body 11 extending along an axial direction (X), and an LED lamp 12. The main body 11 has a positioning member 112, and an outer peripheral surface 111 having front and rear portions 111a, 111b. The front portion 111a of the outer peripheral surface 111 of the main body 11 is formed with an external thread 113. The first sealing member 13 is sleeved on the rear portion 111b of the outer peripheral surface 111 of the main body 11. The LED lamp 12 is disposed in a front end 1151 of the main body 11. The positioning member 112 of the main body 11 extends radially and outwardly from the rear portion 111b of the outer peripheral surface 111 of the main body 11 and defines an annular groove 114 for retaining the first sealing member 13 securely therein.

The rotary unit 20 includes a tube body 30 and a convex lens 40. The tube body 30 extends along the axial direction (X) and surrounds the lamp seat unit 10. The convex lens 40 is mounted fixedly in the tube body 30 at a position in front of the LED lamp 12 of the lamp seat unit 10. In this preferred embodiment, the convex lens 40 is a plano-convex lens.

The tube body 30 has an inner peripheral surface 34, a first shoulder portion 38, and a second shoulder portion 39. The inner peripheral surface 34 has a front region 341 and a rear region 342 opposite to the front region 341 in the axial direction (X). The front region 341 of the inner peripheral surface 34 is formed with an internal thread 37 that threadedly engages the external thread 113 of the main body 11 so as to permit movement of the tube body 30 relative to the lamp seat unit 10 during rotation of the tube body 30 relative to the lamp seat unit 10. The first sealing member 13 is disposed to be rotatable to the tube body 30 and is configured to be in fluid-tight engagement with the rear region 342 of the inner peripheral surface 34 of the tube body 30 when the tube body 30 is rotated relative to the lamp seat unit 10. When the tube body 30 is rotated relative to the lamp seat unit 10, the lamp seat unit 10 is movable in the axial direction (X) between a first position (see FIG. 3), where the convex lens 40 is proximate to the LED lamp 12, and a second position (see FIG. 4), where the convex lens 40 is distal from the LED lamp 12.

The rear region 342 of the inner peripheral surface 34 is configured to be of a dimension larger than that of the front region 341 so as to form a shoulder abutment 343 therebetween. The rear region 342 extends rearward to terminate at an inner peripheral end edge 3421 which defines a rear access opening 3420 to permit the lamp seat unit 10 to be brought in and surrounded by the inner peripheral surface 34 so as to have the external thread 113 of the front portion 111a of the outer peripheral surface 111 of the main body 11 threadedly engaged with the internal thread 37 of the front region 341 of the inner peripheral surface 34. The positioning member 112 is disposed to abut against the shoulder abutment 343 when the lamp seat unit 10 is at the first position.

The LED lighting fixture further comprises a rear end cap 32 and a front end cap 33. The rear end cap 32 is configured to threadedly engage the tube body adjacent to the rear region 342 of the inner peripheral surface 34 so as to cover the rear access opening 3420. The rear end cap 32 is formed with a first through hole 321 that extends in the axial direction (X) to communicate with the rear access opening 3420. The first through hole 321 is configured to be of a dimension smaller than the rear access opening 3420 so as to form a surrounding stop member 36. The surrounding stop member 36 is spaced apart from the shoulder abutment 343, and is configured to abut against the positioning member 112 when the lamp seat unit 10 is at the second position.

The first shoulder portion 38 of the tube body 30 is formed between the LED lamp 12 and the convex lens 40, and extends radially and inwardly from the front region 341 of the inner peripheral surface 34 of the tube body 30. The convex lens 40 is mounted on the first shoulder portion 38 of the tube body 30. The second shoulder portion 39 is formed in front of the first shoulder portion 38, and extends radially and inwardly from the front region 341 of the inner peripheral surface 34 of the tube body 30.

The front region 341 of the inner peripheral surface 34 extends forwardly to terminate at a front tubular end edge 3411 which defines a front access opening 3410 to provide access to the convex lens 40. The front end cap 33 is formed with a second through hole 331 that extends in the axial direction (X) to communicate with the front access opening 3410, and is configured such that the front end cap 33 is insertable into the front access opening 3410 and such that the front end cap 33 threadedly engages the front tubular end edge 3411 for guarding the convex lens 40 against moving away from the first shoulder portion 38.

The LED lighting fixture further comprises a transparent protective lens 50 and a second sealing member 60. The protective lens 50 is mounted on the second shoulder portion 39, and is disposed between the convex lens 40 and the front end cap 33, thereby ensuring that the protective lens 50 is mounted fixedly on the second shoulder portion 39. In this preferred embodiment, the protective lens 50 is made of tampered glass. The second sealing member 60 is disposed between the protective lens 50 and the front end cap 33, and is configured to be in fluid-tight engagement with the front region 341 of the inner peripheral surface 34 of the tube body 30.

The front end cap 33 has a frustoconical outer surrounding wall surface 332 which diverges in a direction away from the convex lens 40, and which is brought to abut against the second sealing member 60. When the front end cap 33 fully and threadedly engages with the front tubular end edge 3411, the frustoconical outer surrounding wall surface 332 presses the second sealing member 60 against the front region 341 of the inner peripheral surface 34 of the tube body 30, thereby ensuring fluid-tight engagement therebetween.

To sum up, the advantages of the LED lighting fixture according to the present invention are as follows. In the present invention, the internal thread 37 of the tube body 30 engages the external thread 113 of the main body 11 such that the lamp seat unit 10 and the rotary unit 20 are jointed together and such that the lamp seat unit 10 is movable relative to the rotary unit 20 during rotation of the tube body 30 relative to the lamp seat unit 10. Thus, it is easier to assemble the LED lighting fixture of the present invention compared to the conventional lighting fixture. The first sealing member 13 is configured to be in fluid-tight engagement with the inner peripheral surface 34 of the tube body 30 when the tube body 30 is rotated relative to the lamp seat unit 10. The second sealing member 60 is configured to be in fluid-tight engagement with the front region 341 of the inner peripheral surface 34 of the tube body 30. As such, the LED lighting fixture of the present invention is waterproof. Furthermore, since the convex lens 40 is mounted directly in the tube body 30, a frame for mounting the convex lens 40 can be omitted, thus reducing manufacturing costs.

What is claimed is:

1. A light emitting diode (LED) lighting fixture comprising:
a lamp seat unit including
a main body that extends along an axial direction, and that has an outer peripheral surface formed with an external thread, and
an LED lamp that is disposed in a front end of said main body; and
a rotary unit including
a tube body that extends along the axial direction, that surrounds said lamp seat unit, and that has an inner peripheral surface formed with an internal thread that threadedly engages said external thread of said main body so as to permit movement of said tube body relative to said lamp seat unit during rotation of said tube body relative to said lamp seat unit, and
a convex lens that is mounted in said tube body at a position in front of said LED lamp of said lamp seat unit, such that when said tube body is rotated relative to said lamp seat unit, said lamp seat unit is movable in the axial direction between a first position, where said convex lens is proximate to said LED lamp, and a second position, where said convex lens is distal from said LED lamp.

2. The LED lighting fixture as claimed in claim 1, wherein said outer peripheral surface of said main body has front and rear portions, one of said front and rear portions of said outer peripheral surface being formed with said external thread, said LED lighting fixture further comprising a first sealing member sleeved securely on the other one of said front and rear portions of said outer peripheral surface of said main body, said first sealing member being disposed to be rotatable to said tube body and configured to be in fluid-tight engagement with said inner peripheral surface of said tube body when said tube body is rotated relative to said lamp seat unit

3. The LED lighting fixture as claimed in claim 2, wherein said front portion of said outer peripheral surface of said main body of said lamp seat unit is formed with said external thread, and said first sealing member is sleeved securely on said outer peripheral surface of said rear portion of said main body.

4. The LED lighting fixture as claimed in claim 3, wherein:
said inner peripheral surface of said tube body has a front region which is formed with said internal thread, and a rear region which is opposite to said front region in the axial direction, and which is configured to be of a dimension larger than that of said front region so as to form a shoulder abutment therebetween, said rear region extending rearward to terminate at an inner peripheral end edge which defines a rear access opening to permit said lamp seat unit to be brought in and surrounded by said inner peripheral surface so as to have said external thread of said front portion of said outer peripheral surface threadedly engaged with said internal thread of said front region; and
said main body of said lamp seat unit further having a positioning member which extends radially and outwardly from said rear portion of said outer peripheral surface of said main body, and which defines an annular groove for retaining said first sealing member therein, said positioning member being disposed to abut against said shoulder abutment when said lamp seat unit is at the first position.

5. The LED lighting fixture as claimed in claim 4, wherein said tube body further has a first shoulder portion formed between said LED lamp and said convex lens, and extending radially and inwardly from said front region of said inner peripheral surface thereof, said convex lens being mounted on said first shoulder portion.

6. The LED lighting fixture as claimed in claim 5, further comprising a rear end cap which is configured to be threadedly engaged with said tube body adjacent to said rear region of said inner peripheral surface so as to cover said rear access opening, and which defines a first through hole that extends in the axial direction to communicate with said rear access opening, said first through hole being configured to be of a dimension smaller than said rear access opening so as to form a surrounding stop member which is spaced apart from said shoulder abutment, and which is configured to abut against said positioning member when said lamp seat unit is at the second position.

7. The LED lighting fixture as claimed in claim 6, wherein:
said tube body extends forwardly to terminate at a front tubular end edge which defines a front access opening to provide access to said convex lens, said LED lighting fixture further comprising a front end cap which is formed with a second through hole that extends in the axial direction to communicate with said front access opening, and which is configured such that said front end cap is insertable into said front access opening and such that said front end cap threadedly engages said front tubular end edge for guarding said convex lens against moving away from said first shoulder portion.

8. The LED lighting fixture as claimed in claim 7, wherein said tube body further has a second shoulder portion formed in front of said first shoulder portion, and extending radially and inwardly from said front region of said inner peripheral surface thereof, said LED lighting fixture further comprising a transparent protective lens which is disposed between said convex lens and said front end cap, and which is mounted fixedly on said second shoulder portion.

9. The LED lighting fixture as claimed in claim 8, further comprising a second sealing member that is disposed between said protective lens and said front end cap, and configured to be in fluid-tight engagement with said front region of said inner peripheral surface of said tube body.

10. The LED lighting fixture as claimed in claim 9, wherein said front end cap has a frustoconical outer surrounding wall surface which diverges in a direction away from said convex lens, and which is brought to abut against said second sealing member, such that when said front end cap threadedly engages said front tubular end edge, said frustoconical outer surrounding wall surface presses said second sealing member against said front region of said inner peripheral surface of said tube body, thereby ensuring fluid-tight engagement therebetween.
